(19) United States
(12) Patent Application Publication
(10) Pub. No.: US 2022/0131168 A1
(43) Pub. Date: Apr. 28, 2022

(54) WATER-CHAIR TYPE ELECTRIC WHEELCHAIR HAVING ENERGY-INDEPENDENT WATER ELECTROLYSIS FUEL CELL

(71) Applicant: KWaterCraft Co., Ltd., Busan (KR)

(72) Inventors: Yong Jin Kwon, Busan (KR); Nam Ju Cho, Gyeongsangnam-do (KR); Kyunghyun Kim, Busan (KR); Myeong Seok Jeong, Busan (KR)

(73) Assignee: KWaterCraft Co., Ltd., Busan (KR)

(21) Appl. No.: 17/436,860

(22) PCT Filed: Jun. 5, 2019
(86) PCT No.: PCT/KR2019/006778

§ 371 Date: Sep. 7, 2021

(30) Foreign Application Priority Data
Mar. 7, 2019 (KR) 10-2019-0026210
Jun. 5, 2019 (KR) PCT/KR2019/006778

(51) Int. Cl. H01M 8/0656; C25B 1/04; H01M 8/0662; A61G 5/04

(52) U.S. Cl. CPC H01M 8/0656; C25B 1/04; H01M 2220/20; A61G 5/041; H01M 8/0662

(57) ABSTRACT

Provided is a water-chair type electric wheelchair system having an energy-independent water electrolysis fuel cell. A water-chair type electric wheelchair system having an energy-independent water electrolysis fuel cell according to the present invention includes: a hydrogen supply unit for performing water electrolysis processing using supplied available water and supplying hydrogen gas to the fuel cell by controlling the pressure of the hydrogen gas produced through the water electrolysis processing, a fuel cell for generating electric energy on the basis of the supplied hydrogen gas; and a battery management unit for supplying power for the water-chair type electric wheelchair system having the energy-independent type water electrolysis fuel cell without requiring separate energy charging. The water-chair type electric wheelchair system having the energy-independent water electrolysis fuel cell can be used as an electric scooter for the elderly or challenged.

### TECHNICAL FIELD

The present disclosure relates to a water-chair type electric wheelchair having an energy-independent water electrolysis fuel cell.

### BACKGROUND ART

A water electrolysis system is a system which generates hydrogen and oxygen by electrochemically decomposing water, and has been in the spotlight as a hydrogen fabrication technology because the system has advantages in that it has a simple operation condition compared to other hydrogen fabrication methods and can obtain high-purity hydrogen having a small volume. In the water electrolysis field in which water is electrolyzed, representative methods include solid oxide electrolysis (SOE), polymer electrolyte membrane electrolysis (PEME), alkaline electrolysis (AE), etc.

In the water electrolysis field, a high temperature vapor electrolytic method is a method using a phenomenon in which electric energy necessary to decompose water is further reduced at a high temperature, and enables high efficiency water decomposition by using small electric energy and enables a directional operation because a structure and a principle are the same as those of a solid oxide cell (SOFC).

A fuel cell is a method of producing electricity by making hydrogen and oxygen electrochemically react with each other, and is one of alternative energy technologies because the fuel cell has less environmental pollution and high energy efficiency compared to an internal combustion engine. In particular, a water electrolysis treatment unit that produces hydrogen by electrolyzing water has been in the spotlight from an eco-environmental aspect in which only oxygen is discharged as byproducts along with hydrogen purity close to 100%.

A polymer electrolyte membrane fuel cell (PEMFC) continues to grow through a wide power supply range and various application fields. As guidelines for regarding the support of new renewable energy equipment are reformed in 2013, the energy yield and a modification factor 6.5 were designated, and the PEMFC is rapidly introduced up to the civilian market in addition to a mandatory market for public institution installation.

Among application fields of the fuel cell, a transport field is focused on the vehicle market. DOOSAN Pure Cell merges with Clear Edge Power and focuses on the production of fuel cells which may be supplied to buildings sand vehicles. Hyundai Motor Company plans to produce hydrogen electric vehicles from January in 2018.

Korea Institute of Energy Research developed a parallel plate high temperature water electrolysis hydrogen fabrication technology which may reuse high-temperature and high-pressure waste heat and water vapor. Ulsan National Institute of Science and Technology (UNIST) developed a solid oxide water electrolysis cell for producing hydrogen of 0.9 L at a time by applying, as perovskite, a dual layer of anode (positive pole) and cathode (negative pole) materials.

Korean Patent Application Publication No. 10-2005-0075628 relates to a high-temperature methane modified hybrid water electrolysis treatment unit, and discloses a technology for efficiently using heat as energy and reducing energy consumption, compared to the existing water electrolysis treatment unit, by simultaneously producing hydrogen according to a water vapor modified reaction of methane and hydrogen according to a high-temperature water electrolysis reaction and using heat generated by a self-heating reaction of methane and heat generated by a full oxidation reaction or partial oxidation reaction of methane in a water electrolysis device that requires a high temperature operation condition.

### DISCLOSURE

### Technical Problem

An object of the present disclosure is to provide a water-chair type electric wheelchair having an energy-independent water electrolysis fuel cell capable of nationally reducing the use of chemical fuel, using an alternative eco-environmental energy, and producing and using energy by eco-environmentally producing hydrogen through water which can be easily obtained anywhere in order to reduce greenhouse gas emission for handling a climate change and to perform obligation for the adaptation of a climate change.

### Technical Solution

In an aspect, a water-chair type electric wheelchair system having an energy-independent water electrolysis fuel cell, which is proposed by the present disclosure, includes a hydrogen supply unit performing water electrolysis treatment by using supplied water, adjusting pressure of hydrogen gas generated through the water electrolysis treatment, and supplying the hydrogen gas to a fuel cell, the fuel cell generating electric energy based on the supplied hydrogen gas, and a battery management unit not requiring separate energy charging and supplying the generated electric energy as electric power for the water-chair type electric wheelchair system having an energy-independent water electrolysis fuel cell. The water-chair type electric wheelchair system having an energy-independent water electrolysis fuel cell may be used as an electric scooter for the elderly and the handicapped.

The hydrogen supply unit includes a solar panel supplying power necessary for initial water electrolysis treatment by using sunlight energy and using the power as reserve power, a water electrolysis treatment unit supplied with filtered and refined water and generating clean hydrogen gas through hydrogen electrolysis using sunlight energy, a gas controller adjusting pressure of the hydrogen gas generated through the water electrolysis treatment and supplying the hydrogen gas, a hydrogen refinement unit converting the generated hydrogen into high-purity clean hydrogen gas through a hydrogen refinement process, and a hydrogen storage unit storing the refined hydrogen gas.

The fuel cell generates electricity by making the hydrogen gas, generated through the water electrolysis treatment and converted into high-purity clean hydrogen gas through a hydrogen refinement process, and oxygen electrochemically react with each other.

The battery management unit does not require separate energy charging and controls extra electricity to be stored in a battery so that driving is possible even without power supply.

In another aspect, a method of supplying power in a water-chair type electric wheelchair system having an energy-independent water electrolysis fuel cell, which is proposed by the present disclosure, includes performing water electrolysis treatment by using supplied water, adjusting pressure of hydrogen gas generated through the water electrolysis treatment, and supplying the hydrogen gas to a fuel cell, generating electric energy based on the supplied hydrogen gas, and supplying the generated electric energy as electric power for the water-chair type electric wheelchair system having an energy-independent water electrolysis fuel cell without requiring separate energy charging.

### Advantageous Effects

According to embodiments of the present disclosure, there can be provided the water-chair type electric wheelchair having an energy-independent water electrolysis fuel cell, which can reduce the use of chemical fuel, can use an alternative eco-environmental energy, and can produce and use energy by eco-environmentally producing hydrogen through water which can be easily obtained anywhere.

### DESCRIPTION OF DRAWINGS

FIG. 1 is a diagram illustrating a schematic diagram of a water-chair type electric wheelchair system having an energy-independent water electrolysis fuel cell according to an embodiment of the present disclosure.

FIG. 2 is a diagram illustrating an aerial view of a water-chair type electric wheelchair system having an energy-independent water electrolysis fuel cell according to an embodiment of the present disclosure.

FIG. 3 is a diagram illustrating a schematic diagram of a water-chair type electric wheelchair system having an energy-independent water electrolysis fuel cell according to another embodiment of the present disclosure.

FIG. 4 is a diagram illustrating an aerial view of a water-chair type electric wheelchair system having an energy-independent water electrolysis fuel cell according to another embodiment of the present disclosure.

FIG. 5 is a flowchart for describing a method of supplying power in the water-chair type electric wheelchair system having an energy-independent water electrolysis fuel cell according to an embodiment of the present disclosure.

### MODE FOR INVENTION

Hereinafter, embodiments of the present disclosure are described in detail with reference to the accompanying drawings.

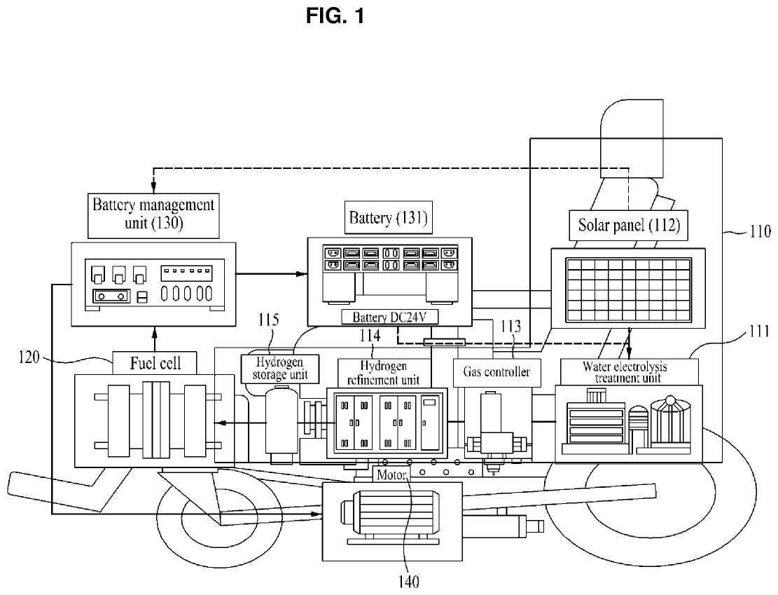

FIG. 1 is a diagram illustrating a schematic diagram of a water-chair type electric wheelchair system having an energy-independent water electrolysis fuel cell according to an embodiment of the present disclosure.

An object of the present disclosure is to develop a water-chair type electric wheelchair having an energy-independent water electrolysis fuel cell, which can produce and use energy by eco-environmentally producing hydrogen through water which can be easily obtained anywhere.

According to an embodiment of the present disclosure, a water-chair type electric wheelchair having an energy-independent water electrolysis fuel cell, which can produce and use energy by eco-environmentally producing hydrogen through water, can be developed. The developed water-chair type electric wheelchair may be used as an electric scooter for the elderly or the handicapped, and does not separately require energy charging unlike a conventional technology. In the state in which power has not been supplied from the outside, an operation may be performed by adjusting pressure of hydrogen gas generated through water electrolysis by using supplied water, supplying the hydrogen gas, and generating power using a polymer electrolyte fuel cell.

Injected water is refined into pure water refined through a filter, etc. and is supplied to a water electrolysis treatment unit. Hydrogen is eco-environmentally produced using a water electrolysis treatment unit, that is, a system which generates hydrogen and oxygen by electrochemically decomposing water. The proposed water-chair type electric wheelchair is an energy independent type water-chair type electric wheelchair, which can produce electricity through a fuel cell for producing electricity by making hydrogen and oxygen electrochemically reach with each other by using generated hydrogen, can store extra electricity in an energy storage device, and can be driven without external power supply. Furthermore, the proposed water-chair type electric wheelchair can supply power necessary for initial water electrolysis driving using a solar cell and can use the power as reserve power.

The proposed water-chair type electric wheelchair system having an energy-independent water electrolysis fuel cell includes a hydrogen supply unit 110, a fuel cell 120 and a battery management unit 130.

The hydrogen supply unit 110 performs water electrolysis treatment by using supplied water, and supplies hydrogen gas to the fuel cell by adjusting pressure of the hydrogen gas generated through the water electrolysis treatment.

The hydrogen supply unit 110 includes a water electrolysis treatment unit 111, a solar panel 112, a gas controller 113, a hydrogen refinement unit 114 and a hydrogen storage unit 115.

The solar panel 112 supplies power necessary for initial water electrolysis treatment by using sunlight energy, and uses the power as reserve power.

The water electrolysis treatment unit 111 is supplied with filtered and refined water, and produces clean hydrogen gas through hydrogen electrolysis using sunlight energy.

The gas controller 113 adjusts pressure of the hydrogen gas generated through the water electrolysis treatment, and supplies the hydrogen gas.

The hydrogen refinement unit 114 converts the generated hydrogen into high-purity clean hydrogen gas through a hydrogen refinement process.

The hydrogen storage unit 115 stores the refined hydrogen gas.

The fuel cell 120 generates electric energy based on the supplied hydrogen gas. The fuel cell 120 generates electricity by making the hydrogen gas, produced through the water electrolysis treatment and converted into high-purity clean hydrogen gas through the hydrogen refinement process, and oxygen electrochemically react with each other.

The battery management unit 130 does not require separate energy charging, and supplies the generated electric energy as electric power for the water-chair type electric wheelchair system having an energy-independent water electrolysis fuel cell. The battery management unit 130 does not require separate energy charging, and controls extra electricity to be stored in a battery 131 so that driving is possible even without the supply of power.

Such a water-chair type electric wheelchair system having an energy-independent water electrolysis fuel cell may be used as an electric scooter for the elderly and the handicapped.

The water-chair type electric wheelchair system having an energy-independent water electrolysis fuel cell according to an embodiment may have a form, such as FIG. 1.

A motor 140 may drive the water-chair type electric wheelchair illustrated in FIG. 1 by using electric power supplied by the battery management unit 130. In the embodiment illustrated in FIG. 1, stability can be improved because the motor 140 drives both the front wheel and rear wheel of the water-chair type electric wheelchair.

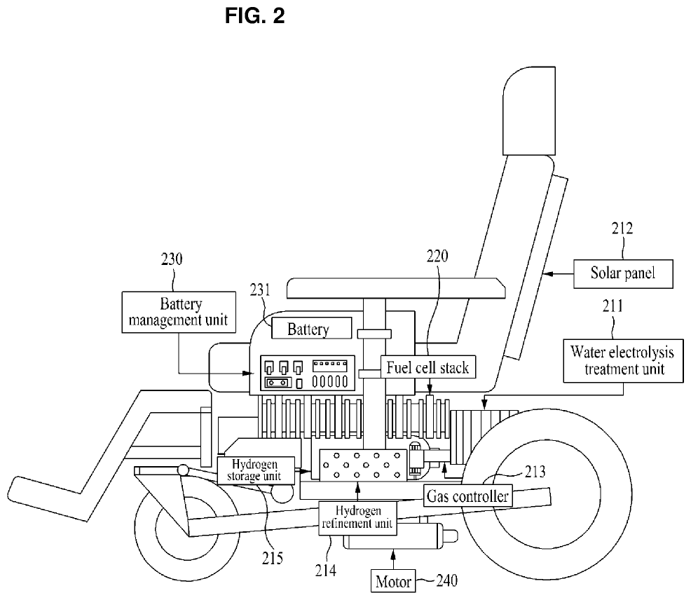

FIG. 2 is a diagram illustrating an aerial view of a water-chair type electric wheelchair system having an energy-independent water electrolysis fuel cell according to an embodiment of the present disclosure.

As described above, a proposed water-chair type electric wheelchair system having an energy-independent water electrolysis fuel cell includes a water electrolysis treatment unit 211, a solar panel 212, a gas controller 213, a hydrogen refinement unit 214, a hydrogen storage unit 215, a fuel cell stack 220 and a battery management unit 230.

The solar panel 212 supplies power necessary for initial water electrolysis treatment by using sunlight energy, and uses the power as reserve power. The water electrolysis treatment unit 211 is supplied with filtered and refined water, and generates clean hydrogen gas through hydrogen electrolysis using sunlight energy. The gas controller 213 adjusts pressure of the hydrogen gas generated through water electrolysis treatment, and supplies the hydrogen. The hydrogen refinement unit 214 converts the generated hydrogen into high-purity clean hydrogen gas through a hydrogen refinement process, and stores the refined hydrogen gas in the hydrogen storage unit 215.

The fuel cell stack 220 generates electric energy based on the supplied hydrogen gas, and may have a stacked form as in FIG. 2. The fuel cell stack 220 generates electricity by making the hydrogen gas, generated through the water electrolysis treatment and converted into high-purity clean hydrogen gas through the hydrogen refinement process, and oxygen electrochemically react with each other.

The battery management unit 230 does not require separate energy charging, and supplies the generated electric energy as electric power for the water-chair type electric wheelchair system having an energy-independent water electrolysis fuel cell. The battery management unit 230 does not require separate energy charging, and controls extra electricity to be stored in the battery 231 even without the supply of power. A motor 240 may drive the water-chair type electric wheelchair illustrated in FIG. 2 by using electric power supplied by the battery management unit 230.

Such a water-chair type electric wheelchair system having an energy-independent water electrolysis fuel cell may be used as an electric scooter for the elderly and the handicapped.

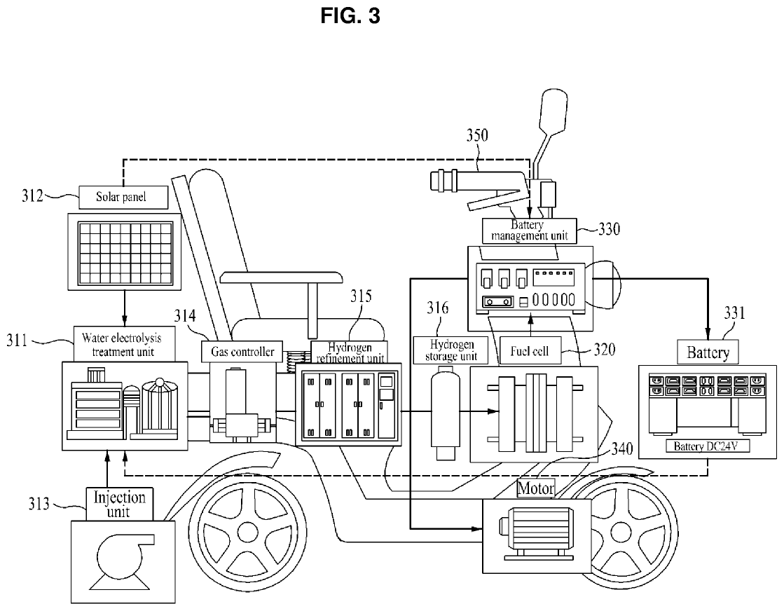

FIG. 3 is a diagram illustrating a schematic diagram of a water-chair type electric wheelchair system having an energy-independent water electrolysis fuel cell according to another embodiment of the present disclosure.

The proposed water-chair type electric wheelchair system having an energy-independent water electrolysis fuel cell includes a water electrolysis treatment unit 311, a solar panel 312, an injection unit 313, a gas controller 314, a hydrogen refinement unit 315, a hydrogen storage unit 316, a fuel cell 320 and a battery management unit 330.

The solar panel 312 supplies power necessary for initial water electrolysis treatment by using sunlight energy, and uses the power as reserve power.

The water electrolysis treatment unit 311 is supplied with filtered and refined water through the injection unit 313, and generates clean hydrogen gas through hydrogen electrolysis using sunlight energy.

The gas controller 314 adjusts pressure of the hydrogen gas generated through the water electrolysis treatment, and supplies the hydrogen gas.

The hydrogen refinement unit 315 converts the generated hydrogen into high-purity clean hydrogen gas through a hydrogen refinement process.

The hydrogen storage unit 316 stores the refined hydrogen gas.

The fuel cell 320 generates electric energy based on the supplied hydrogen gas. The fuel cell 320 generates electricity by making the hydrogen gas, generated through the water electrolysis treatment and converted into high-purity clean hydrogen gas through the hydrogen refinement process, and oxygen electrochemically react with each other.

The battery management unit 330 does not require separate energy charging, and supplies the generated electric energy as electric power for the water-chair type electric wheelchair system having an energy-independent water electrolysis fuel cell. The battery management unit 330 does not require separate energy charging, and controls extra electricity to be stored in a battery 331 so that driving is possible even without the supply of power.

Such a water-chair type electric wheelchair system having an energy-independent water electrolysis fuel cell may be used as an electric scooter for the elderly and the handicapped.

The water-chair type electric wheelchair system having an energy-independent water electrolysis fuel cell according to an embodiment may have a form, such as FIG. 3.

A motor 340 may drive the water-chair type electric wheelchair illustrated in FIG. 3 by electric power supplied by the battery management unit 330. In the embodiment illustrated in FIG. 3, a motor 340 may drive the front wheel of the water-chair type electric wheelchair. A direction can be easily changed using a handle 350.

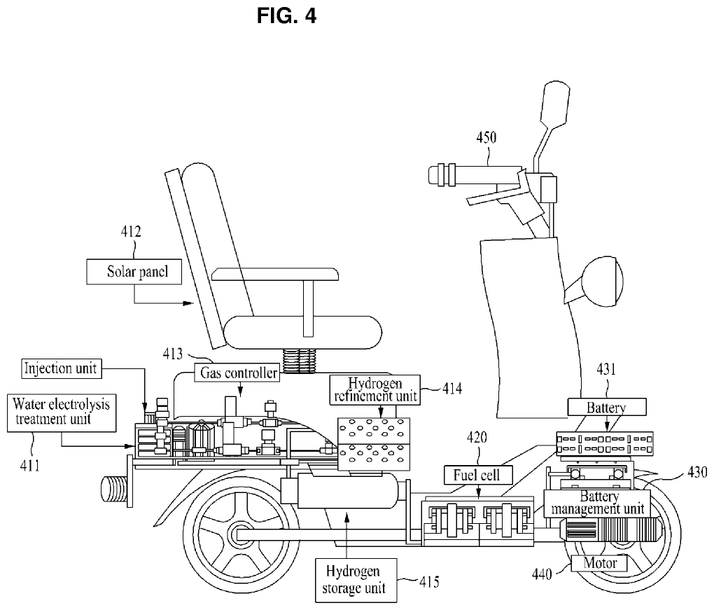

FIG. 4 is a diagram illustrating an aerial view of a water-chair type electric wheelchair system having an energy-independent water electrolysis fuel cell according to another embodiment of the present disclosure.

As described above, the proposed water-chair type electric wheelchair system having an energy-independent water electrolysis fuel cell includes a water electrolysis treatment unit 411, a solar panel 412, a gas controller 413, a hydrogen refinement unit 414, a hydrogen storage unit 415, a fuel cell 420 and a battery management unit 430.

The solar panel 412 supplies power necessary for initial water electrolysis treatment by using sunlight energy, and uses the power as reserve power. The water electrolysis treatment unit 411 is supplied with filtered and refined water, and generates clean hydrogen gas through hydrogen electrolysis using sunlight energy. The gas controller 413 adjusts pressure of the hydrogen gas generated through the water electrolysis treatment, and supplies the hydrogen gas. The hydrogen refinement unit 414 converts the generated hydrogen into high-purity clean hydrogen gas through a hydrogen refinement process, and stores the refined hydrogen gas in the hydrogen storage unit 415.

The fuel cell 420 generates electric energy based on the supplied hydrogen gas, and may have a stacked form as in FIG. 4. The fuel cell 420 generates electricity by making the hydrogen gas, generated through the water electrolysis treatment and converted into high-purity clean hydrogen gas through the hydrogen refinement process, and oxygen electrochemically react with each other.

The battery management unit 430 does not require separate energy charging, and supplies the generated electric energy as electric power for the water-chair type electric wheelchair system having an energy-independent water electrolysis fuel cell. The battery management unit 430 does not require separate energy charging, and controls extra electricity to be stored in a battery 431 so that driving is possible even without the supply of power. A motor 440 may drive the water-chair type electric wheelchair illustrated in FIG. 4 by using electric power supplied by the battery management unit 430.

Such a water-chair type electric wheelchair system having an energy-independent water electrolysis fuel cell may be used as an electric scooter for the elderly and the handicapped.

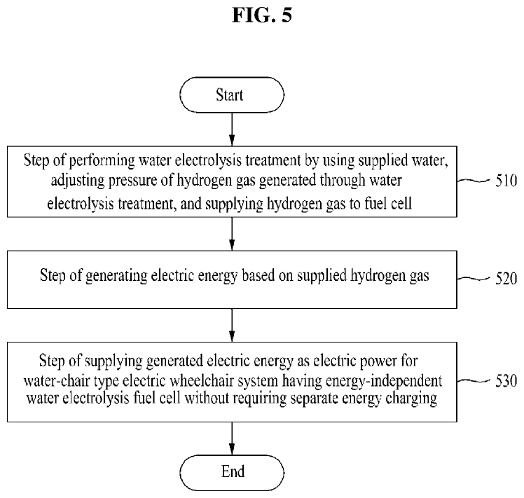

FIG. 5 is a flowchart for describing a method of supplying power in the water-chair type electric wheelchair system having an energy-independent water electrolysis fuel cell according to an embodiment of the present disclosure.

An object of the present disclosure is to develop a water-chair type electric wheelchair having an energy-independent water electrolysis fuel cell, which can produce and use energy by eco-environmentally producing hydrogen through water which can be easily obtained anywhere.

According to an embodiment of the present disclosure, a water-chair type electric wheelchair having an energy-independent water electrolysis fuel cell, which can produce and use energy by eco-environmentally producing hydrogen through water, can be developed. The developed water-chair type electric wheelchair may be used as an electric scooter for the elderly or the handicapped, and does not separately require energy charging unlike a conventional technology. In the state in which power has not been supplied from the outside, an operation may be performed by adjusting pressure of hydrogen gas generated through water electrolysis by using supplied water, supplying the hydrogen gas, and generating power using a polymer electrolyte fuel cell.

Injected water is refined into pure water refined through a filter, etc. and is supplied to a water electrolysis treatment unit. Hydrogen is eco-environmentally produced using a water electrolysis treatment unit, that is, a system which generates hydrogen and oxygen by electrochemically decomposing water. The proposed water-chair type electric wheelchair is an energy independent type water-chair type electric wheelchair, which can produce electricity through a fuel cell for producing electricity by making hydrogen and oxygen electrochemically reach with each other by using generated hydrogen, can store extra electricity in an energy storage device, and can be driven without external power supply. Furthermore, the proposed water-chair type electric wheelchair can supply power necessary for initial water electrolysis driving using a solar cell and can use the power as reserve power.

The proposed method of supplying power in the water-chair type electric wheelchair system having an energy-independent water electrolysis fuel cell may include step 510 of performing water electrolysis treatment by using supplied water, adjusting pressure of hydrogen gas generated through the water electrolysis treatment, and supplying the hydrogen gas to the fuel cell, step 520 of generating electric energy based on the supplied hydrogen gas, and step 530 of supplying the generated electric energy as electric power for the water-chair type electric wheelchair system having an energy-independent water electrolysis fuel cell without requiring separate energy charging.

In step 510, the hydrogen supply unit performs water electrolysis treatment by using supplied water, adjusts pressure of hydrogen gas generated through the water electrolysis treatment, and supplies the hydrogen gas to the fuel cell. The solar panel supplies power necessary for initial water electrolysis treatment by using sunlight energy, and uses the power as reserve power. The water electrolysis treatment unit is supplied with filtered and refined water, and generates clean hydrogen gas through hydrogen electrolysis using sunlight energy. The gas controller adjusts pressure of the hydrogen gas generated through the water electrolysis treatment, and supplies the hydrogen gas. The hydrogen refinement unit converts the generated hydrogen into high-purity clean hydrogen gas through a hydrogen refinement process. The hydrogen storage unit stores the refined hydrogen gas.

In step 520, the fuel cell generates electric energy based on the supplied hydrogen gas. The fuel cell generates electricity by making the hydrogen gas, generated through the water electrolysis treatment and converted into high-purity clean hydrogen gas through the hydrogen refinement process, and oxygen electrochemically react with each other.

In step 530, the battery management unit does not require separate energy charging, and supplies the generated electric energy as electric power for the water-chair type electric wheelchair system having an energy-independent water electrolysis fuel cell. The battery management unit does not require separate energy charging, and controls extra electricity to be stored in the battery so that driving is possible even without the supply of power. Such a method of supplying power in the water-chair type electric wheelchair system having an energy-independent water electrolysis fuel cell may be applied to an electric scooter for the elderly and the handicapped.

The aforementioned device may be implemented by a hardware component, a software component and/or a combination of a hardware component and a software component. For example, the device and component described in the embodiments may be implemented using a processor, a controller, an arithmetic logic unit (ALU), a digital signal processor, a microcomputer, a field programmable gate array (FPGA), a programmable logic unit (PLU), a microprocessor or one or more general-purpose computers or special-purpose computers, such as any other device capable of executing or responding to an instruction. The processing device may perform an operating system (OS) and one or more software applications executed on the OS. Furthermore, the processing device may access, store, manipulate, process and generate data in response to the execution of software. For convenience of understanding, one processing device has been illustrated as being used, but a person having ordinary skill in the art may understand that the processing device may include a plurality of processing elements and/or a plurality of types of processing elements. For example, the processing device may include a plurality of processors or a single processor and a single controller. Furthermore, a different processing configuration, such as a parallel processor, is also possible.

Software may include a computer program, a code, an instruction or a combination of one or more of them and may configure a processing device so that the processing device operates as desired or may instruct the processing devices independently or collectively. The software and/or the data may be embodied in any type of machine, a component, a physical device, a computer storage medium or a device in order to be interpreted by the processor or to provide an instruction or data to the processing device. The software may be distributed to computer systems connected over a network and may be stored or executed in a distributed manner. The software and the data may be stored in one or more computer-readable recording media.

The method according to the embodiment may be implemented in the form of a program instruction executable by various computer means and stored in a computer-readable recording medium. The computer-readable recording medium may include a program instruction, a data file, and a data structure alone or in combination. The program instruction stored in the medium may be specially designed and constructed for an embodiment, or may be known and available to those skilled in the computer software field. Examples of the computer-readable medium include magnetic media such as a hard disk, a floppy disk and a magnetic tape, optical media such as a CD-ROM and a DVD, magneto-optical media such as a floptical disk, and hardware devices specially configured to store and execute a program instruction, such as a ROM, a RAM, and a flash memory. Examples of the program instruction include not only machine language code produced by a compiler, but a high-level language code which may be executed by a computer using an interpreter, etc.

As described above, although the embodiments have been described in connection with the limited embodiments and the drawings, those skilled in the art may modify and change the embodiments in various ways from the description. For example, proper results may be achieved although the aforementioned descriptions are performed in order different from that of the described method and/or the aforementioned components, such as the system, configuration, device, and circuit, are coupled or combined in a form different from that of the described method or replaced or substituted with other components or equivalents.

Accordingly, other implementations, other embodiments, and the equivalents of the claims fall within the scope of the claims.

1. A water-chair type electric wheelchair system having an energy-independent water electrolysis fuel cell, comprising:
a hydrogen supply unit performing water electrolysis treatment by using supplied water, adjusting pressure of hydrogen gas generated through the water electrolysis treatment, and supplying the hydrogen gas to a fuel cell;
the fuel cell generating electric energy based on the supplied hydrogen gas; and
a battery management unit not requiring separate energy charging and supplying the generated electric energy as electric power for the water-chair type electric wheelchair system having an energy-independent water electrolysis fuel cell,
wherein the water-chair type electric wheelchair system having an energy-independent water electrolysis fuel cell is capable of being used as an electric scooter for an elderly and a handicapped.

2. The water-chair type electric wheelchair system of claim 1, wherein the hydrogen supply unit comprises:
a solar panel supplying power necessary for initial water electrolysis treatment by using sunlight energy and using the power as reserve power;
a water electrolysis treatment unit supplied with filtered and refined water and generating clean hydrogen gas through hydrogen electrolysis using sunlight energy;
a gas controller adjusting pressure of the hydrogen gas generated through the water electrolysis treatment and supplying the hydrogen gas;
a hydrogen refinement unit converting the generated hydrogen into high-purity clean hydrogen gas through a hydrogen refinement process; and
a hydrogen storage unit storing the refined hydrogen gas.

3. The water-chair type electric wheelchair system of claim 1, wherein the fuel cell generates electricity by making the hydrogen gas, generated through the water electrolysis treatment and converted into high-purity clean hydrogen gas through a hydrogen refinement process, and oxygen electrochemically react with each other.

4. The water-chair type electric wheelchair system of claim 1, wherein the battery management unit does not require separate energy charging and controls extra electricity to be stored in a battery so that driving is possible even without power supply.

5. A method of supplying power in a water-chair type electric wheelchair system having an energy-independent water electrolysis fuel cell, comprising:
performing water electrolysis treatment by using supplied water, adjusting pressure of hydrogen gas generated through the water electrolysis treatment, and supplying the hydrogen gas to a fuel cell;
generating electric energy based on the supplied hydrogen gas; and
supplying the generated electric energy as electric power for the water-chair type electric wheelchair system having an energy-independent water electrolysis fuel cell without requiring separate energy charging,
wherein the method of supplying power in the water-chair type electric wheelchair system having an energy-independent water electrolysis fuel cell is applicable to an electric scooter for an elderly and a handicapped.

6. The method of claim 5, wherein performing water electrolysis treatment by using supplied water, adjusting pressure of hydrogen gas generated through the water electrolysis treatment, and supplying the hydrogen gas to a fuel cell comprises:
supplying power necessary for initial water electrolysis treatment by using sunlight energy and using the power as reserve power;
generating clean hydrogen gas through hydrogen electrolysis using sunlight energy by using filtered, refined and supplied water;
adjusting pressure of the hydrogen gas generated through the water electrolysis treatment;
converting the generated hydrogen into high-purity clean hydrogen gas through a hydrogen refinement process; and
storing the high-purity clean hydrogen gas.

7. The method of claim 5, wherein supplying the generated electric energy as electric power for the water-chair type electric wheelchair system having an energy-independent water electrolysis fuel cell without requiring separate energy charging comprises controlling extra electricity to be stored in a battery so that driving is possible even without power supply without requiring separate energy charging.
